(19) United States
(12) Patent Application Publication
(10) Pub. No.: US 2006/0104559 A1
(43) Pub. Date: May 18, 2006

(54) Side shields for fractured outer ring bearing

(76) Inventors: Paul T. Wingett, Mesa, AZ (US); Brent L. Bristol, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/991,751

(22) Filed: Nov. 17, 2004

(51) Int. Cl. F16C 33/60

(52) U.S. Cl. 384/503

(57) ABSTRACT

A bearing assembly is provided that has an inner and outer ring, a plurality of balls therebetween, and a side shield. The rings each have an inner peripheral surface, an outer peripheral surface and first and second sides extending therebetween. The outer ring is concentric to the inner ring, and includes a fracture extending between the inner and outer peripheral surfaces and a groove formed between the outer ring first side and outer peripheral surface. The side shield includes a retainer section coupled to a shield section. The retainer section couples to one of the outer ring first and second sides and the annular flange extends from the retainer section and is disposed within the groove to clamp the outer ring fracture. The shield section extends from the retainer section at least partially to the inner ring first side without contacting the inner ring first side.

The present invention relates to bearing assemblies and, more particularly, to an outer ring of the bearing assembly.

### BACKGROUND OF THE INVENTION

Many machines, such as space vehicles, terrestrial vehicles and seagoing vessels, can include one or more rotating groups and may include, for example, a motor/generator and a shaft. In many instances, the shaft is rotationally supported using one or more bearing assemblies. Bearing assemblies typically include an inner ring, an outer ring, and a plurality of balls disposed in a space therebetween. Bearing assemblies may be any size; for example, in machines employing energy flywheel storage systems, a bearing assembly may be relatively small compared to bearing assemblies used for automobiles.

For optimal performance, friction between the balls and rings is preferably minimized. In this regard, the races preferably each have smooth surfaces for contacting the balls, and lubricant is disposed within the assemblies. Additionally, the inner and outer rings may each be machined from a single piece of material and include a raceway for receiving the balls.

In order to load a full complement of balls between the raceways, the outer ring may include a fracture in one section that allows an assembler to expand the diameter of the outer ring. When the bearing assembly is implemented into its desired environment, a retaining ring may then be used to maintain the outer ring at its original diameter. Typically, the retaining ring is mated with a groove formed in the outer diameter of the outer ring.

Although the above-described bearing assembly is generally well-designed, it may suffer from certain drawbacks. For example, during operation, lubricant may eject out of the bearing assembly which may contaminate other assembly components. In other configurations, a side shield would be used to prevent lubricant expulsion, however, in small-sized bearing assemblies, such as those used in energy flywheel storage systems, mounting a side shield to the bearing assembly has been found to be problematic. In particular, conventional shields include a flange that is designed to mate with a notch formed in the inner peripheral surface of the outer ring; but, because a retaining ring groove already exists in the outer ring outer diameter, too little material of the outer ring is available for the formation of an additional notch in the shield. Particularly, an additional notch in the outer ring may compromise its structural integrity.

Hence, there is a need for a bearing assembly that improves on one or more of the above-noted drawbacks. Namely, a bearing assembly that is configured to maintain lubricant within the bearing assembly and/or having a retaining configuration capable of maintaining the structural integrity of the outer ring is desired. The present invention addresses one or more of these needs.

### BRIEF SUMMARY

The present invention provides a bearing assembly having an inner ring, an outer ring, a plurality of balls, and a first side shield. The inner ring has an inner peripheral surface, an outer peripheral surface, and first and second sides extending therebetween. The outer ring is disposed concentric to the inner ring, and has an inner peripheral surface, an outer peripheral surface, first and second sides, a fracture, and a first groove. The fracture extends between the inner and outer peripheral surfaces and the first groove is formed on the outer peripheral surface. The plurality of balls is disposed between the inner and outer rings. The first side shield has a retainer section coupled to a shield section. The retainer section has a contact surface and an annular flange. The contact surface is coupled to the outer ring first side, the annular flange extends from the retainer section and disposed within the first groove to clamp the outer ring fracture, and the shield section extends from the retainer section at least partially to the inner ring first side without contacting the inner ring first side.

In another embodiment, and by way of example only, an energy storage flywheel system is provided that includes a housing assembly, a shaft, a flywheel assembly, and one or more bearing assemblies. The shaft is disposed within the housing assembly and the flywheel assembly is mounted on the shaft. The one or more bearing assemblies is disposed within the housing assembly and coupled to the shaft. The bearing assembly is configured to selectively rotationally support the shaft and includes an inner ring, an outer ring, a plurality of balls, and a first side shield. The inner ring has an inner peripheral surface, an outer peripheral surface, and first and second sides extending therebetween. The outer ring is disposed concentric to the inner ring and has an inner peripheral surface, an outer peripheral surface, first and second sides, a fracture, and a first groove. The fracture extends between the inner and outer peripheral surfaces, and the first groove is formed on the outer peripheral surface. The plurality of balls is disposed between the inner and outer rings. The first side shield has a retainer section coupled to a shield section. The retainer section has a contact surface and an annular flange. The contact surface is coupled to the outer ring first side, the annular flange extends from the retainer section and disposed within the first groove to clamp the outer ring fracture, and the shield section extends from the retainer section at least partially to the inner ring first side without contacting the inner ring first side.

Other independent features and advantages of the preferred side shield will become apparent from the following detailed description, taken in conjunction with the accompanying drawings which illustrate, by way of example, the principles of the invention.

### BRIEF DESCRIPTION OF THE DRAWINGS

FIG. 1 is a cross section view of an exemplary bearing assembly; and

FIG. 2 is a cross section view of exemplary flywheel energy storage system within which the bearing assembly of FIG. 1 may be implemented.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

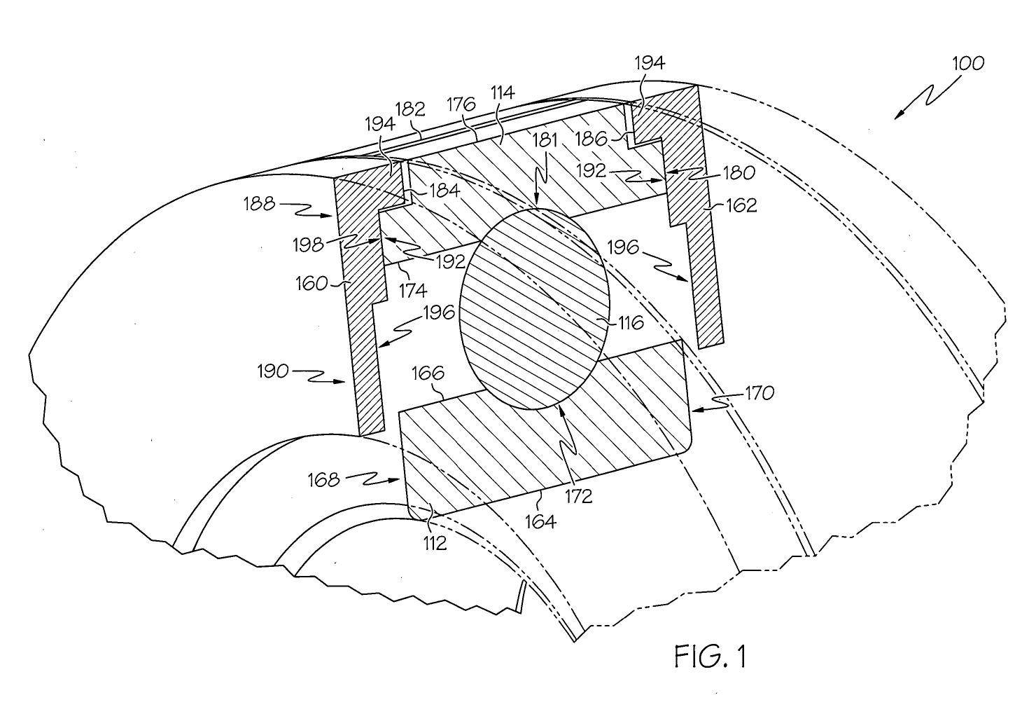

Turning now to the description and with reference to FIG. 1 the bearing assembly 100 includes an inner ring 112, an outer ring 114, a plurality of spherical rolling elements 116, and two side shields 160, 162. In general, the inner and outer rings 112, 114 are configured to hold the plurality of spherical rolling elements 116, such as balls, therebetween.

The inner ring 112 is generally annular and preferably formed from a single piece of material. In this regard, the inner ring 112 may be constructed via any one of numerous methods. The inner ring 112 has an inner peripheral surface 164, an outer peripheral surface 166, and two side walls 168, 170 that extend therebetween. The outer peripheral surface 166 includes a raceway 172 formed therein that is configured to receive the spherical rolling elements 116.

The outer ring 114 is also generally annular and preferably formed from a single piece of material. The outer ring 114 may be constructed of the same or different material as the inner ring 112. Similar to the inner ring 112, the outer ring 114 also includes an inner peripheral surface 174, an outer peripheral surface 176, first and second side walls 178, 180, and a raceway 181; however, unlike the inner ring 112, the outer ring 114 also includes a fracture 182 and two grooves 184, 186 formed therein.

When the outer ring 114 is unclamped, the fracture 182 is a gap in the outer ring 114 that allows expansion thereof for easier loading of the rolling elements 116 during assembly of the bearing assembly 100. The fracture 182 extends through the outer ring 114 from its inner peripheral surface 174 to its outer peripheral surface 180 and may be formed in the outer ring 114 via any one of numerous manners. For example, in one exemplary embodiment, before the fracture 182 is formed, the outer ring 114 is a continuous ring and has an initiation groove machined into it and is then placed into extreme cold temperatures. The outer ring 114 is then tapped at the initiation groove to cause a clean breakage.

The two grooves 184, 186 are each formed on the outer peripheral surface 180 of the outer ring 114 and are used to clamp the outer ring 114 to close the fracture 182. In the exemplary embodiment depicted in FIG. 1, the grooves 184, 186 are formed along the two annular edges of the outer ring 114 where the outer peripheral surface 174 meets the first and second side walls 178, 180.

The two side shields 160, 162 clamp and close the outer ring 114 while also preventing lubricant from ejecting out of the bearing assembly 110. The shields 160, 162 may have any one of numerous appropriate configurations, such as annular, as illustrated in FIG. 1 and may be made of any one of numerous materials, such as metal; however, preferably, each of the shields 160, 162 includes a retainer section 188 and a shield section 190. The two sections 188, 190 are preferably formed from a single piece of material; however, it will be appreciated that the sections 188, 190 may alternatively be made of multiple pieces and subsequently bonded together to form one piece.

The retainer section 188 has a contact surface 192 that is configured to couple to the outer ring 114. The contact surface 192 includes an annular retainer flange 194 that extends therefrom and is configured to be disposed in one of the grooves 184, 186. The retainer flange 194 is preferably formed as an extension from the same piece of material as the retainer section 188; however, it will be appreciated that the retainer flange 194 may be a separate annular piece of material that is bonded to the retainer section 188. The retainer flange 194 preferably provides an interference fit with the outer ring 114 that allows it to remain located in its appropriate groove 184, 186. Thus, when the retainer flange 194 is appropriately mounted, it clamps the outer ring 114 to close the fracture 182 and to return the diameter of the outer ring 114 to its original dimensions.

The shield section 190 extends from the retainer section 188 and is configured to extend at least partially along a portion of the inner ring side wall 168, 170 without contacting the inner ring side wall 168, 170; to this end, the shield section 190 can have any one of numerous configurations. In one exemplary embodiment, the shield section 190 is annular and has a thickness that is less than the thickness of the retainer section 188. In another exemplary embodiment, each shield section 190 has an inner surface 196, and the distance between the inner surfaces 196 of the first and second side shields 160, 162 is greater than the distance between the contact surfaces 192 of the shields 160, 162.

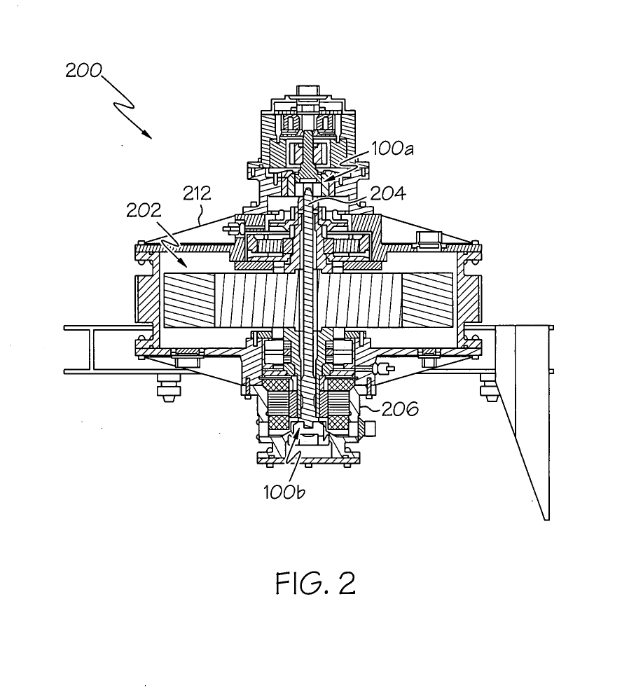

It will be appreciated that the bearing assembly 100 may be implemented into any one of numerous rotating machines. In one exemplary embodiment, the bearing assembly 100 is integrated into an energy flywheel system 100, such as the one illustrated in FIG. 2. The depicted energy storage flywheel system 100 includes a flywheel assembly 202, a shaft assembly 204, a motor/generator 206, a first and second plurality of bearing assemblies 100a, 100b, all of which are mounted within a housing assembly 212. The flywheel assembly 202 is mounted to the shaft assembly 204 which, in turn, is coupled to the motor/generator 206. The first and second plurality of bearing assemblies 100a, 100b are each mounted around the shaft assembly 204.

Thus, a bearing assembly is now provided that has a retaining configuration that maintains lubricant therein. Additionally, the retaining configuration is capable clamping the fractured outer ring together without compromising its structural integrity.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A bearing assembly comprising:
an inner ring having an inner peripheral surface, an outer peripheral surface, and first and second sides extending therebetween;
an outer ring disposed concentric to the inner ring, the outer ring having an inner peripheral surface, an outer peripheral surface, first and second sides extending between the outer ring inner and outer peripheral surfaces, a fracture, and a groove, the fracture extending between the outer ring inner and outer peripheral surfaces, the groove formed on the outer peripheral surface;
a plurality of balls disposed between the inner and outer rings; and
a side shield having a retainer section coupled to a shield section, the retainer section having a contact surface and an annular flange, the contact surface coupled to the outer ring first side, the annular flange extending from the retainer section and disposed within the groove to clamp the outer ring fracture, and the shield section extending from the retainer section at least partially to the inner ring first side without contacting the inner ring first side.

2. The assembly of claim 1, wherein:
the retainer section and the shield section each has a thickness; and
the thickness of the retainer section is greater than the thickness of the shield section.

3. The assembly of claim 1, wherein:
the outer ring comprises a second groove formed on the outer peripheral surface; and
the assembly further comprises a second side shield having a retainer section and a shield section, the retainer section having a contact surface and an annular flange, the contact surface coupled to one of the outer ring first and second sides and the annular flange extending from the retainer section, the annular flange disposed within the second groove to clamp the outer ring fracture, the side shield extending from the outer ring second side at least partially to the inner ring second side without contacting the inner ring second side.

4. The assembly of claim 3, wherein:
the shield sections of each of the first and second side shields has an inner surface; and
the distance between the inner surfaces of the first and second side shields is less than the distance between the contact surfaces of the first and second side shields.

5. The assembly of claim 1, wherein the side shield comprises metal material.

6. The assembly of claim 1, wherein the shield section and retainer section are formed from a single piece of material.

7. The assembly of claim 1, wherein the shield section and retainer section are formed from separate pieces of material and bonded together.

8. The assembly of claim 1, wherein the retainer flange and retainer section are formed from a single piece of material.

9. The assembly of claim 1, wherein the retainer flange and retainer section are formed from separate pieces are material and are bonded together.

10. The assembly of claim 1, wherein the groove is formed between the outer ring first side and outer peripheral surface.

11. An energy storage flywheel system, comprising:
a housing assembly;
a shaft disposed within the housing assembly;
a flywheel assembly mounted on the shaft; and
one or more bearing assemblies disposed within the housing assembly and coupled to the shaft, bearing assembly configured to selectively rotationally support the shaft and including:
an inner ring having an inner peripheral surface, an outer peripheral surface, and first and second sides extending therebetween;
an outer ring disposed concentric to the inner ring, the outer ring having an inner peripheral surface, an outer peripheral surface, first and second sides extending between the outer ring inner and outer peripheral surfaces, a fracture, and a groove, the fracture extending between the outer ring inner and outer peripheral surfaces, the groove formed on the outer peripheral surface;
a plurality of balls disposed between the inner and outer rings; and
a side shield having a retainer section coupled to a shield section, the retainer section having a contact surface and an annular flange, the contact surface coupled to the outer ring first side, the annular flange extending from the retainer section and disposed within the groove to clamp the outer ring fracture, and the shield section extending from the retainer section at least partially to the inner ring first side without contacting the inner ring first side.

12. The assembly of claim 11, wherein:
the retainer section and the shield section each has a thickness; and
the thickness of the retainer section is greater than the thickness of the shield section.

13. The assembly of claim 11, wherein:
the outer ring comprises a second groove formed on the outer peripheral surface; and
the assembly further comprises a second side shield having a retainer section and a shield section, the retainer section having a contact surface and an annular flange, the contact surface coupled to one of the outer ring first and second sides and the annular flange extending from the retainer section, the annular flange disposed within the second groove to clamp the outer ring fracture, the side shield extending from the outer ring second side at least partially to the inner ring second side without contacting the inner ring second side.

14. The assembly of claim 13, wherein:
the shield sections of each of the first and second side shields has an inner surface; and
the distance between the inner surfaces of the first and second side shields is less than the distance between the contact surfaces of the first and second side shields.

15. The assembly of claim 11, wherein the side shield comprises metal material.

16. The assembly of claim 11, wherein the shield section and retainer section are formed from a single piece of material.

17. The assembly of claim 11, wherein the shield section and retainer section are formed from separate pieces of material and bonded together.

18. The assembly of claim 11, wherein the retainer flange and retainer section are formed from a single piece of material.

19. The assembly of claim 11, wherein the retainer flange and retainer section are formed from separate pieces are material and are bonded together.

20. The assembly of claim 11, wherein the groove is formed between the outer ring first side and outer peripheral surface.
